(19) United States
(12) Patent Application Publication
(10) Pub. No.: US 2010/0124633 A1
(43) Pub. Date: May 20, 2010

(54) UNITARY MAT FOR PLAYGROUNDS AND THE LIKE AND METHOD FOR FORMING SAME

(75) Inventor: Keith Sacks, Brick, NJ (US)

Correspondence Address: FRISHAUF, HOLTZ, GOODMAN & CHICK, PC, 220 Fifth Avenue, 16TH Floor, NEW YORK, NY, 10001-7708, US

(73) Assignee: PLAYSAFER SURFACING LLC, LAKEWOOD, NJ (US)

(21) Appl. No.: 12/464,987

(22) Filed: May 13, 2009

Related U.S. Application Data
(60) Provisional application No. 61/199,293, filed on Nov. 14, 2008.

(51) Int. Cl. E01C 13/06; E04B 1/16; B05D 5/02

(52) U.S. Cl. 428/147; 427/203; 427/136

(57) ABSTRACT

Method for manufacturing a unitary mat on site includes placing loose fill material into a defined area in which the mat is to be formed, mixing rubber particles with at least one binder to form a mixture, placing the mixture over the loose fill material, and allowing the mixture to dry whereby the dried mixture in combination with the loose fill material forms the unitary mat. In one embodiment, the loose fill material includes only rubber particles, without a binder. The mixture placed over these loose rubber particles seals and contains the loose rubber particles. The mixture may incorporate color, e.g., by adding a colorant to the mixture and/or using colored rubber particles. Alternatively or additionally, an additional, colored mixture may be prepared and placed over the dried mixture.

This application claims the benefit under 35 USC 119 of the filing date of U.S. Provisional Patent Application Ser. No. 61/199,293 filed Nov. 14, 2008, the entire contents of which is incorporated herein by reference.

### FIELD OF THE INVENTION

The present invention relates generally to a unitary support mat for playgrounds and the like, and a method for forming same on site.

### BACKGROUND OF THE INVENTION

Old tires and other rubber articles may be ground into rubber particles suitable for recycling. Presently, finished goods produced from recycled rubber are made by either vulcanizing the rubber or by making composites using ground rubber and polyurethane binders.

In the polyurethane binder process, a mixture of ground rubber (crumb rubber) and one or more polyurethane binders is molded or formed and cured. The binder may be cured in a “hot-cure” process, at elevated temperatures, or in a “cold-cure” process, at ambient temperature and at ambient or low pressures. Cold-cure processes are typically used when the mixture is cured on-site, for example, for playground mats, running tracks, and floors for animal stalls.

An example of the use of a cold-cure process is U.S. Pat. No. 6,896,964 (Kvesic) which describes a method for fabricating a playground mat in which a mold is formed at the installation site and a filler material is poured into the mold (the entire disclosure of which is incorporated herein by reference). The filler material may be concrete, asphalt, landscape cloth, crumb rubber, stone, sand, metal, a polymer membrane, or a combination thereof. A rubber composite mixture including treated rubber and a binder, which may be a urethane binder, is mixed and placed over the filler material. This rubber-containing layer is then finished, e.g., smoothed, and allowed to cure or set. Once this layer sets, a second layer may be formed. The color of each layer may be selected as desired, e.g., the second layer may be colored whereas the first is not colored.

Additional prior art which describes various ways to form support mats includes U.S. Pat. Nos. 3,446,122 (Raichle et al.) and 4,564,310 (Thelen et al.), the entire disclosure of each of which is disclosed herein by reference. Raichle et al. describe a multi-layer artificial mat for playgrounds which includes a filler layer of sand or gravel and a sub-base of rigid foam and a dispersion. The rigid foam and dispersion are mixed on site and then applied over the filler layer. Thelen et al. describe a multi-layer mat in which the lowest layer includes wood or sand and another layer above this lowest layer includes a core composition having rubber. The core composition is mixed on site and then applied over the wood or sand.

It would be desirable to provide an Improved unitary mat for playgrounds and the like, and method for forming a unitary mat for playgrounds and the like on site and using a cold-cure process.

### OBJECTS AND SUMMARY OF THE INVENTION

It is an object of the present invention to provide new and improved unitary mat and method for forming a unitary mat on site. Such a method is also referred to as a “poured in place” or PIP method.

In order to achieve this object and others, a first embodiment of a method for manufacturing a unitary mat on site in accordance with the invention includes placing loose fill material into a defined area in which the mat is to be formed, mixing rubber particles with at least one binder to form a mixture, placing the mixture over the loose fill material, and allowing the mixture to dry whereby the dried mixture in combination with the loose fill material forms the unitary mat.

In one embodiment, the loose fill material includes only rubber particles, without a binder. The mixture placed over these loose rubber particles seals and contains the loose rubber particles.

The mixture may incorporate color, e.g., by adding a colorant to the mixture and/or using colored rubber particles. Alternatively or additionally, a colored mixture may be prepared and placed over the dried mixture.

One embodiment of a unitary mat in accordance with the invention would therefore include a base layer of only loose rubber particles without a binder, and a rubber layer including rubber particles and at least one binder which has reacted with the rubber to form a unitary mat when dried, in combination with the loose rubber particles. The rubber layer seals and contains the base layer to thereby prevent shifting and movement of the loose rubber particles of the base layer.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a flow chart of a method for forming a unitary mat in accordance with the invention;

FIG. 2 is a cross-section of a first embodiment of a unitary mat in accordance with the invention; and

FIG. 3 is a cross-section of a second embodiment of a unitary mat in accordance with the invention.

### DETAILED DESCRIPTION OF THE INVENTION

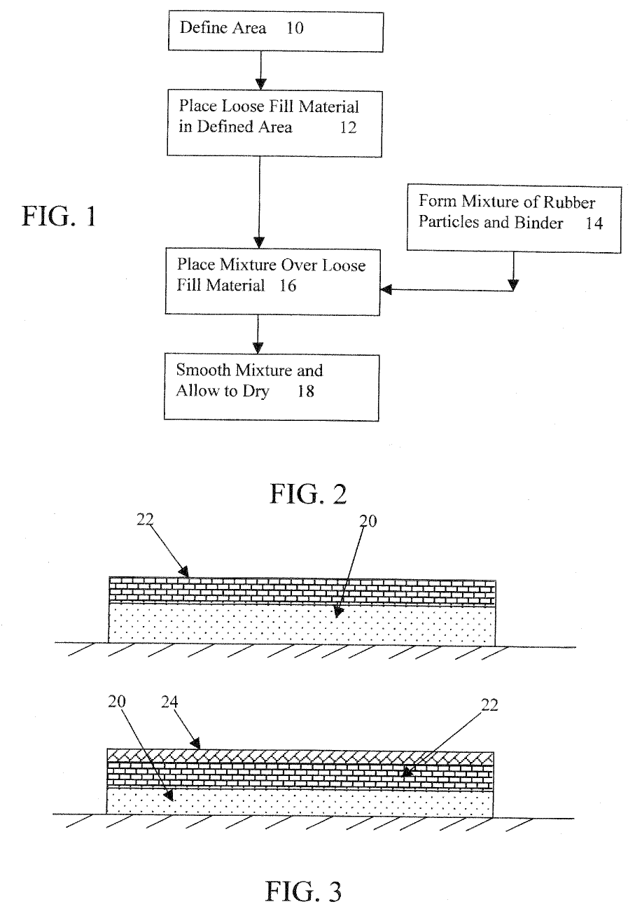

Referring to the accompanying drawings wherein like reference numerals refer to the same or similar elements, FIG. 1 is a flow chart showing an exemplifying method for manufacturing a unitary mat on site in accordance with the invention. The site at which the mat is to be formed must first be selected and prepared. Selection of the site may be a determination of a site for a playground, running track, athletic field, etc. Preparation of the site may include defining an area in which the mat is to be formed, step 10, and then placing loose fill material into the defined area, step 12. To define the area, the underlying ground surface may be worked as known to those skilled in the art. Alternatively, the ground surface does not have to be worked and may be left as is, e.g., ungraded, because the loose fill material will naturally fill in any voids or depressions in the ground surface.

The loose fill material constitutes a base layer and may include any material or combination of materials that meets the ASTM 1292 standard for impact attenuation. Examples of such materials include rubber mulch, wood chips, shredded tire rubber, pea gravel and loose foam. In a preferred embodiment, the loose fill material would include only recycled rubber particles without any binder.

A rubber-containing mixture which will cover the loose fill material is also prepared, step 14. The rubber-containing mixture includes rubber particles and one or more binders which will bind the rubber. The rubber particles and binder(s) are placed into a mixer, which would likely be situated at or proximate the prepared site at which the mat is to be formed. The mixer may be similar to a portable cement mixer. Although rubber particles are preferred, any shock-absorbing material may be used in the invention. The rubber particles preferably have a granule size from about 0.5 mm to about 4 mm and/or may be thermoplastic vulcanized (TPV) granules. However larger or smaller sizes are acceptable.

The rubber particles may be fine rubber crumbs, small rubber chunks, rubber slivers/buffing and combinations thereof. Further, the rubber particles may be recycled rubber particles, e.g., from used tires or other rubber products such as shredded recycled tires.

The binders may each be any binder known to those skilled in the art which interacts with rubber particles and binds the rubber particles into a cohesive unit, e.g., when the binder is exposed to air for a certain amount of time. An example of a common binder used in this field is polyurethane. Two other types of common binders are SBR and acrylic binders. SBR binders are often used to increase sealing performance with oils. SBR binders generally will cause a material to swell or expand when in contact with oils. This property provides increased sealing performance by allowing the material to seal potential leak paths in an application. SBR materials offer better sealing performance with less than ideal sealing flange surfaces, or between dissimilar sealing surfaces, such as a stamped-pan sealing against a cast surface area. H&V material grade names that begin with the letter “S” use an SBR binder system. Acrylic binders are similar to those used in paints.

Specific techniques to mix rubber particles and a binder are disclosed in U.S. Pat. No. 6,896,964, the entire disclosure of which is incorporated herein by reference above. A binder as used herein will also include any suitable liquid or polymeric liquid precursor that subsequently can form a polymer upon exposure to moisture in the air.

After the mixture is prepared and while still in its liquid form, it is placed over the loose fill material, step 16. For example, the mixture can be transported by a wheel barrow or buckets from the portable mixer to the defined area. The fluid mixture may be prevented from flowing outside of the area by appropriate shaping and working. The mixture is then allowed to dry (cure), step 18.

If the mixture will provide the uppermost layer of the unitary mat when dry, then the mixture is preferably smoothed after it has been placed into the defined area and before it dries. The mixture may be smoothed by workers using trowels or by any other smoothing means known to those skilled in the art. The area may then be surrounded by a fence to prevent intruders from disturbing the curing process, or other security measures may be undertaken.

FIG. 2 shows the different layers of the unitary mat including a base layer 20 of the loose fill material and an upper layer 22 of the dried rubber-containing mixture above the loose fill material. The edges of the unitary mat may be smoothed into the ground and not pronounced as shown.

In another embodiment of the invention, a second mixture is formed and placed over the above mixture after it has dried. This second mixture may be colored, e.g., by adding one or more colorants to the mixture and/or using colored rubber particles. The colorant is mixed with the rubber particles and the binder(s) in the portable mixer after drying of the first mixture, e.g., a day later, and then placed over the dried first mixture. If the second mixture is to be applied, the first mixture would not have to be smoothed after it is applied since it is being covered by the colored mixture and thus only the colored mixture would have to be smoothed, assuming it provides the uppermost surface of the mat. Any number of additional layers over the first layer may be provided.

FIG. 3 shows the different layers of the unitary mat including a base layer 20 of the loose fill material, an intermediate layer 22 of the first rubber-containing mixture and a colored rubber-containing layer 24 above the intermediate layer 22.

With the foregoing structure, a unitary mat in accordance with the invention provides significant advantages over prior art unitary mats. A major advantage stems from the fact that the base layer includes loose fill material, which is not limited to rubber materials and may include only non-rubber materials, only loose rubber materials without a binder, only recycled material, or only recycled loose rubber materials without a binder. By contrast, in prior art unitary mats, the base layer is often comprised exclusively of rubber granules that are contained in either a bagged system (Smarte) or are mixed with polyurethane binders that form them into a unitary structure.

Accordingly, a major advantage provided by the invention is that binders and a containment system, e.g., a frame, are not required to enable formation of the base layer. Rather, the loose fill material is maintained in place by placement of the mixture over it and the subsequent drying of the mixture. The dried rubber-containing mixture serves to seal and contain the loose fill material, while preventing shifting and movement thereof. The dried rubber-containing mixture also maintains the impact attenuation of the loose fill material which is generally higher than that of other materials used as a base layer for unitary mats. Although loose fill material in a base layer of a unitary mat can scatter or decompose over time (for example when children pick up the material and throw it outside the play area), the dried rubber-containing mixture prevents such scattering and decomposition in the unitary mat in accordance with the invention, and adequately retains the loose fill material in the unitary mat. Moreover, the dried rubber-containing mixture is strong enough to withstand the flexibility of the loose fill materials.

Additional advantages include a reduction in labor to install the unitary mat, a greater impact attenuation than conventional unitary mats which are formed on site, the ability to use 100% recycled materials in both the base layer and the rubber-containing layer(s) formed over the base layer, the ability to modify existing unitary mats having loose fill material, the ability to color the unitary mat on site, and the relatively easy maintenance of the unitary mat.

Another advantage is the ability to eliminate expensive EPDM (Ethylene Propylene Diene Monomer) materials from the binding process. EPDM materials are synthetically produced and very strong making them ideal for use in playground mats, aside from their relative high cost. As a result, rubber particles or granules may be used in the top layer which are considerably softer than EPDM materials.

Nevertheless, some embodiments of a mat in accordance with the invention, and the method for forming the mat, may include a top layer with EPDM materials and TPV granules. An SBR blend may also be used, e.g., ground up tires, which includes small particulates that are blended with a binder/coloring agent.

Yet another advantage is a reduction in the time needed to form the unitary mat in comparison to prior art unitary mat formation methods in which a sub-base of crushed stone or asphalt, a base layer and a top coat are required. In accordance with the invention, grading of the site at which the unitary mat is to be formed is not required because the loose fill material will fill voids in the ground and moreover, a sub-base is not required.

In sum, a unitary mat formed in accordance with the invention will maintain the most effective Head Injury Criterion (HIC) and G-max scores that are mandated by CPSC and ASTM while maintaining the characteristics needed for ADA accessibility. HIC is an empirical measure of impact severity based on published research describing the relationship between the magnitude and the duration of impact accelerations and the risk of head trauma. G-max is the measure of maximum acceleration (shock) produced by an impact.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention.

1. A method for manufacturing a unitary mat on site, comprising:
placing loose fill material into a defined area in which the mat is to be formed;
mixing rubber particles with at least one binder to form a mixture;
placing the mixture over the loose fill material; and
allowing the mixture to dry whereby the dried mixture in combination with the loose fill material forms the unitary mat.

2. The method of claim 1, wherein the loose fill material is selected from a group consisting of rubber mulch, wood chips, shredded tire rubber, pea gravel and loose foam.

3. The method of claim 1, wherein the loose fill material includes only rubber particles without a binder.

4. The method of claim 3, wherein the rubber particles of the loose fill material and the rubber particles of the mixture are recycled rubber particles.

5. The method of claim 1, wherein the rubber particles are recycled rubber particles.

6. The method of claim 1, wherein the rubber particles are selected from a group consisting of fine rubber crumbs, small rubber chunks and rubber slivers.

7. The method of claim 1, wherein the binder is polyurethane.

8. The method of claim 1, further comprising mixing at least one colorant with the rubber particles and the at least one binder.

9. The method of claim 1, wherein the loose fill material is not contained.

10. The method of claim 1, further comprising:
after the mixture has dried,
incorporating color into an additional mixture of rubber particles and at least one binder;
placing this colored mixture over the dried mixture; and then
allowing the colored mixture to dry whereby the dried colored mixture provides a colored uppermost surface to the unitary mat.

11. The method of claim 10, wherein the color is incorporated into the additional mixture by adding at least one colorant.

12. The method of claim 10, wherein the color is incorporated into the additional mixture by using colored rubber particles.

13. A method for manufacturing a unitary mat on site, comprising:
placing only loose rubber particles, without a binder, onto an ungraded area in which the unitary mat is to be formed;
mixing rubber particles with at least one binder to form a mixture;
placing the mixture over the loose rubber particles; and
allowing the mixture to dry whereby the dried mixture in combination with the loose rubber particles forms the unitary mat.

14. The method of claim 13, wherein the loose rubber particles placed onto the ungraded area and the rubber particles placed into the mixture are recycled rubber particles.

15. The method of claim 13, further comprising mixing at least one colorant with the rubber particles and the at least one binder.

16. The method of claim 13, further comprising:
after the mixture has dried,
incorporating color into an additional mixture of rubber particles and at least one binder;
placing this colored mixture over the dried mixture; and
smoothing the colored mixture and allowing the colored mixture to dry whereby the dried colored mixture provides a colored uppermost surface to the unitary mat.

17. The method of claim 16, wherein the color is incorporated into the additional mixture by adding at least one colorant.

18. The method of claim 16, wherein the color is incorporated into the additional mixture by using colored rubber particles.

19. A unitary mat, comprising:
a base layer of only loose rubber particles without a binder; and
a first rubber-containing layer including rubber particles and at least one binder which has reacted with the rubber to form a unitary mat when dried,
said rubber-containing layer sealing and containing said base layer to thereby prevent shifting and movement of said loose rubber particles of said base layer.

20. The mat of claim 19, further comprising a second, colored rubber-containing layer arranged over said first rubber-containing layer.
